(19) United States
(12) Patent Application Publication
(10) Pub. No.: US 2012/0278217 A1
(43) Pub. Date: Nov. 1, 2012

(54) SYSTEMS AND METHODS FOR IMPROVING PREDICTION OF FUTURE CREDIT RISK PERFORMANCES

(75) Inventors: Xuebin Sui, Libertyville, IL (US); Andrew Podosenov, Chicago, IL (US); David Ellis, Chicago, IL (US)

(73) Assignee: TRANS UNION LLC, Chicago, IL (US)

(21) Appl. No.: 13/434,706

(22) Filed: Mar. 29, 2012

Related U.S. Application Data
(60) Provisional application No. 61/469,781, filed on Mar. 30, 2011.

(51) Int. Cl. G06Q 40/00

(52) U.S. Cl. 705/35

(57) ABSTRACT

Systems and methods are provided for improving prediction of credit risk performances of a plurality of consumers, each consumer having a standard credit data file and score. According to a particular aspect, a method determines changes in credit data files of the plurality of consumers during a predetermined period of time, and combines change data with standard credit data. The method determines a set of credit elements that are predictive of credit risk performances of the plurality of customers by processing the combined change data and standard credit data, and identifies an incremental risk value for each of the plurality of consumers by supplementing the corresponding credit data file with the predictive set of credit elements. The method further generates a flag indicative of the identified incremental risk value for each of the plurality of consumers.

### CROSS-REFERENCE TO RELATED APPLICATION

This application claims priority to U.S. Patent Application No. 61/469,781, filed on Mar. 30, 2011, entitled “SYSTEM AND METHOD FOR IMPROVING PREDICTION OF FUTURE CREDIT RISK PERFORMANCES”, and is incorporated herein by reference in its entirety.

### TECHNICAL FIELD

This invention, generally, relates to the credit scoring industry and, more particularly, to systems and methods for improving prediction of a future credit risk performance of a consumer.

### BACKGROUND OF THE INVENTION

Traditional credit data is typically a raw dataset contained within a consumer's credit file as reported by credit grantors to a consumer credit reporting agency. For example, the data can reflect a consumer's performance on a loan including whether a consumer is meeting all obligations, paying as agreed, or is delinquent in making loan payments. The reported data may also include credit limits, outstanding balances, and payment terms for a particular consumer.

Credit characteristics or attributes are typically based on the raw data within a consumer's credit file. These credit attributes represent an aggregate view of a consumer's credit file by summarizing his/her individual credit attributes. Credit attributes can include for example the number of times a consumer has been sixty (60) days or greater past due on their credit accounts in the last 60, 90, or 180 days, the total credit limits on all bankcard tradelines or accounts, the total balance on all bank cards, and the number of bank card trade lines.

Traditional credit data also includes risk scores that represent the likelihood a consumer will become delinquent on a credit account within a specified period of time. Risk scores are calculated using data from a single point in time—usually the current credit file for a consumer. The traditional risk score, or “credit score” is based on a model that predicts the likelihood a consumer will become 90 days or more delinquent within a specified period of time, generally in the next 18-24 months. The credit score model generates a score for the consumer based on both the raw data in a consumer's credit file and the credit attributes that are generated from the raw data. Credit scores are not static numbers; they typically change every time corresponding credit reports change.

Although credit scores change based on changing credit reports, credit scores from different points in time are not typically compared to each other to identify particular trends in the consumer's credit profile. However, such a comparison may help predict the likelihood of a future credit performance of the consumer. As such, it would be advantageous to provide early-risk credit scores for consumers, to predict the short-term risk levels of these consumers and provide substantial credit score improvements over existing credit reports to inquiring loan and credit card institutions.

Therefore, there exists a need for improved credit risk evaluation systems and methods that utilize changes in a credit file of a consumer from a specific point in time to a prior version of the consumer's credit file to more accurately predict future or short term credit performances of the consumer.

### SUMMARY OF THE INVENTION

The invention is defined by the appended claims. This description summarizes aspects of the embodiments and should not be used to limit the claims.

The invention is intended to solve the above-noted business and technical problems by providing systems and methods for improving prediction of credit risk performances of a plurality of consumers, each consumer having an associated standard credit data file and score. The method determines changes in credit data files of the plurality of consumers during a predetermined period of time, and combines change data with standard credit data. The method determines a set of credit elements that are predictive of credit risk performances of the plurality of customers by processing the combined change data and standard credit data, and identifies an incremental risk value for each of the plurality of consumers by supplementing the corresponding credit data file with the predictive set of credit elements. The method further generates a flag indicative of the identified incremental risk value for each of the plurality of consumers.

In another aspect of the invention, a non-transitory computer-readable medium comprising computer-readable instructions for improving prediction of credit risk performances of a plurality of consumers is provided. The non-transitory computer-readable instructions, when executed by a computer, cause the computer to perform the method steps discussed above.

### BRIEF DESCRIPTION OF THE DRAWINGS

For a better understanding of the invention, reference may be had to embodiments shown in the following drawings in which:

FIG. 1 is a block diagram illustrating one form of a computer or server of FIG. 2, having a memory element with a computer readable medium for implementing the computing system and method of the present invention.

FIG. 2 is a block diagram illustrating a networked computing system for collecting and processing credit information associated with consumers for generating credit risk scores for consumers in accordance with an embodiment of the invention;

FIG. 3 is a block diagram illustrating the process of determining early-risk credit scores in accordance with an embodiment of the invention;

FIG. 4 is block diagram illustrating diverse sets of data combined to form the breadth of data utilized in the process to derive the early-risk splitter (ERS) solution in accordance with an embodiment of the invention;

FIG. 5 is a graph illustrating the process of identifying change data in accordance with an embodiment of the invention;

FIG. 6 is a block diagram illustrating a optimization and regression process for developing the ERS solution in accordance with an embodiment of the invention;

FIG. 7 is a block diagram illustrating a process for benchmarking and generating flags representative of increased levels of risk of accounts becoming 90 days or greater delinquent in a predetermined future period in accordance with an embodiment of the invention;

FIG. 8 is a table illustrating the lifts that ERS flags can provide to traditional credit scores of existing accounts in accordance with an embodiment of the invention;

FIG. 9 is a graph illustrating acquisition of accounts based on their respective ERS flags or scores in accordance with an embodiment of the invention;

FIG. 10 is a flow diagram illustrating a process for generating an ERS score in accordance with the an embodiment of the invention; and

### DETAILED DESCRIPTION OF PREFERRED EMBODIMENTS

While the invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

In accordance with one or more principles of the invention, systems and methods are provided for generating a credit risk solution, such as an ERS flag or score, which serves to predict short-term risk levels of consumers and to provide substantial and informative credit rating supplements to existing credit reports. The ERS flag is a credit risk solution that is configured to identify consumers at increased risk for future delinquency on one or more of their credit accounts. This ERS flag combines traditional credit data and credit scores with daily changes to a consumer's credit file to predict future credit risk performance (hereafter, the daily credit file changes will be referred to as “daily change data” or “triggers data”). As such, the ERS flag is configured to supplement and enhance a credit grantor's existing risk management process by helping to identify accounts that are likely to have risk performance that is worse than their current risk profile or credit score is able to predict. In addition to the ERS flag, an ERS score can also be generated to reflect a prediction of future credit risk performance based on daily changes to the consumer's credit file. This ERS score may be configured to reflect a value of the consumer's credit score as affected by the daily changes to the consumer's credit file. Hereafter, any discussion related to the ERS flag would also be applicable to the ERS score.

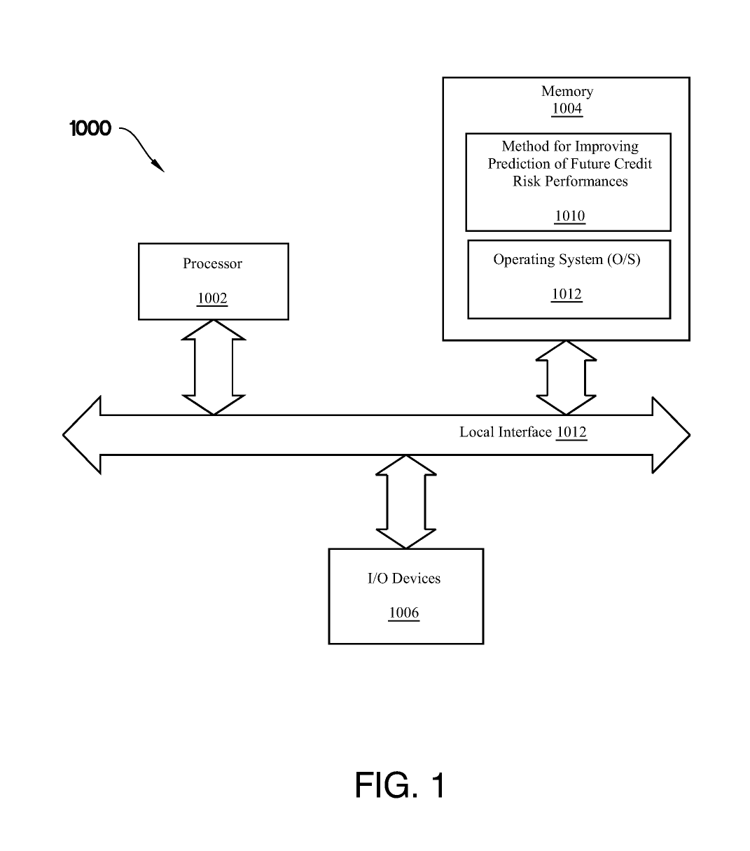

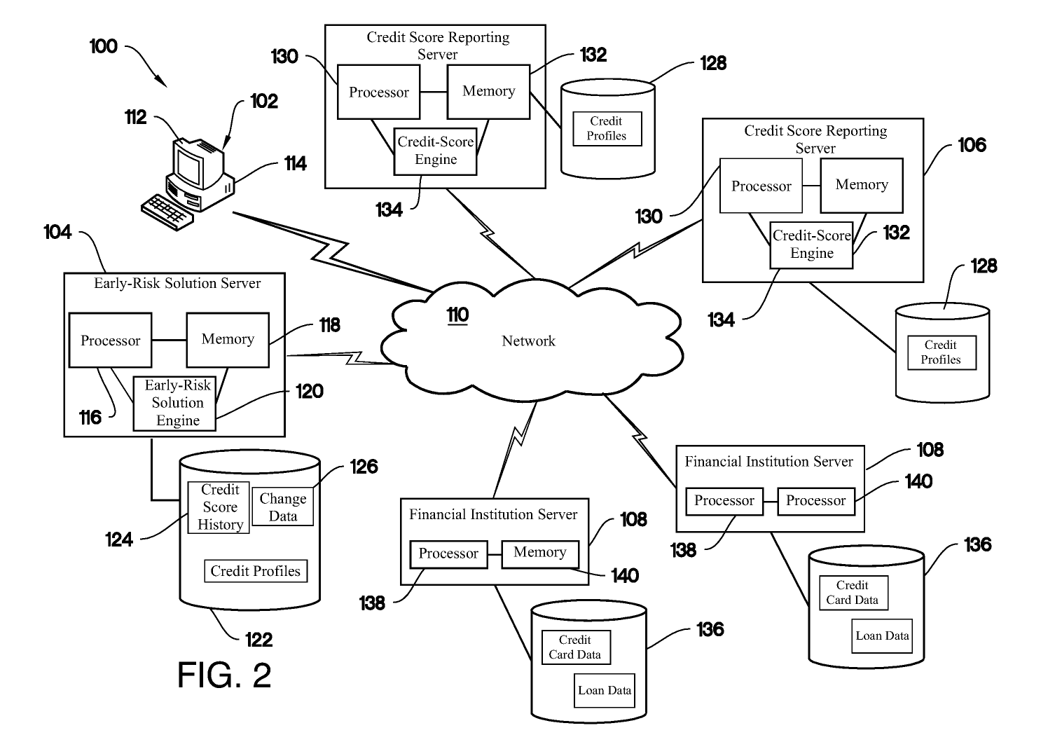

The system and method of the present invention can be implemented with a computer. Referring to FIG. 1, a block diagram of a computer 1000 is illustrated. The computer 1000 may be any one of the user computer 102, the credit server 104, the credit score reporting server 106 or the financial institution server 108 of FIG. 2 or any computer associated with the networked system 100, or any computer utilized in connection with, or to effectuate, one or more methods or processes described herein. Without loss of generality and as an exemplary computer, the credit sever 104 is discussed hereafter. The computer 1000 may include a memory element 1004. The memory element 1004 may include a computer readable medium for implementing the method 1010 for improving prediction of future credit risk performances.

The method 1010 may be implemented in software, firmware, hardware, or any combination thereof. For example, in one mode, the method 1010 is implemented in software, as an executable program, and is executed by one or more special or general purpose digital computer(s), such as a personal computer (PC; IBM-compatible, Apple-compatible, or otherwise), personal digital assistant, workstation, minicomputer, mainframe computer, computer network, “virtual network” or “interne cloud computing facility”. Therefore, computer 1000 may be representative of any computer in which the method 1010 resides or partially resides.

Generally, in terms of hardware architecture, as shown in FIG. 1, the computer 1000 includes a processor 1002, memory 1004, and one or more input and/or output (I/O) devices 1006 (or peripherals) that are communicatively coupled via a local interface 1008. The local interface 1008 may be, for example, but is not limited to, one or more buses or other wired or wireless connections, as is known in the art. The local interface 1008 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 1002 is a hardware device for executing software, particularly software stored in memory 1004. Processor 1002 can be any custom made or commercially available processor, a central processing unit (CPU), an auxiliary processor among several processors associated with the computer 1000, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor 1002 may also represent a distributed processing architecture such as, but not limited to, SQL, Smalltalk, APL, KLisp, Snobol, Developer 200, MUMPS/Magic.

Memory 1004 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 1104 may incorporate electronic, magnetic, optical, and/or other types of storage media. Memory 1004 can have a distributed architecture where various components are situated remote from one another, but are still accessed by processor 1002.

The software in memory 1004 may include one or more separate programs. The separate programs comprise ordered listings of executable instructions for implementing logical functions. In the example of FIG. 1, the software in memory 1004 includes the method 1010 in accordance with the invention, a suitable operating system (O/S) 1012. A non-exhaustive list of examples of suitable commercially available operating systems 1012 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Hewlett-Packard Company, Windows CE, and Mobile 7 available from Microsoft Corporation, Symbian from Nokia, Android from Google, Inc, and Apple iOS for iPhones, iPod Touch, and iPads from Apple, Inc). Operating system 1112 essentially controls the execution of other computer programs, such as the method 1010, and provides scheduling, input-output control, file and data management, memory management, and communication control and related services.

The method 1010 may be a source program, executable program (object code), script, or any other entity comprising a set of instructions to be performed. When a “source” program, the program needs to be translated via a compiler, assembler, interpreter, or the like, which may or may not be included within the memory 1004, so as to operate properly in connection with the O/S 1012. Furthermore, the platform system 1010 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada. In one embodiment, the platform system 1010 is written in Java.

The I/O devices 1006 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices 1006 may also include output devices, for example but not limited to, output modules for PLCs, a printer, bar code printers, displays, etc. Finally, the I/O devices 1006 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

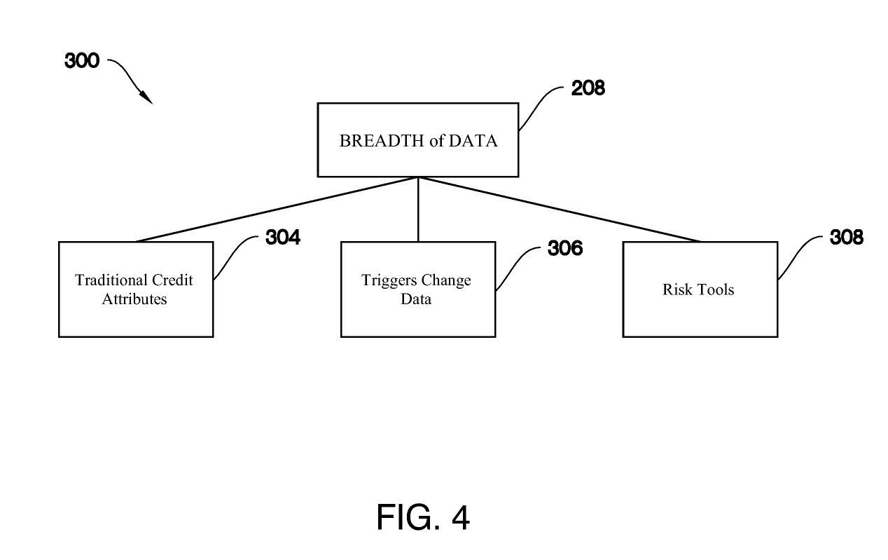

If the computer 1000 is a PC, workstation, PDA, or the like, the software in the memory 1004 may further include a basic input output system (BIOS) (not shown in FIG. 4). The BIOS is a set of essential software routines that initialize and test hardware at startup, start the O/S 1012, and support the transfer of data among the hardware devices. The BIOS is stored in ROM so that the BIOS can be executed when computer 1000 is activated.

When computer 1000 is in operation, processor 1002 is configured to execute software stored within memory 1104, to communicate data to and from memory 1004, and to generally control operations of computer 1000 pursuant to the software. The method 1010, and the O/S 1012, in whole or in part, but typically the latter, may be read by processor 1002, buffered within the processor 1002, and then executed.

When the method 1010 is implemented in software, as is shown in FIG. 1, it should be noted that the method 1010 can be stored on any computer readable medium for use by or in connection with any computer related system or method, although in one preferred embodiment, the method 1010 is implemented in a centralized application service provider arrangement. In the context of this document, a computer readable medium is an electronic, magnetic, optical, or other physical device or means that can contain or store a computer program for use by or in connection with a computer related system or method. The method 1010 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the method 1010 is implemented in hardware, the method 1010 may also be implemented with any of the following technologies, or a combination thereof, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Now referring to FIG. 2 a networked system 100 for collecting and processing credit information associated with consumers is shown in accordance with a particular embodiment of the invention. In the exemplary embodiment of FIG. 2 the networked system 100 comprises a user computer 102 and a server 104, both communicatively connected to at least one credit score reporting server 106 and at least one financial institution server 108 through a network 110 (e.g. the Internet). The user computer 102 may include a computer monitor 112 and a desktop processing unit 114. In the depicted embodiment, the server 104 may include a processor unit 116, a memory unit 118 and a risk solution engine unit 120, and is coupled to a database 122 that include credit score history data 123 and credit change data 126. Each of the credit score reporting servers 106 is coupled to a credit profile database 128, and may include a processor unit 130, a memory unit 132 and a credit score engine 134. Each of the financial institution servers 108 is coupled to a database 136, and may also include a processor unit 138 and a memory unit 140. The user computer 102 and the server 104 may be connected through a local area network (LAN). Alternatively, the user computer 102 and the server 104 may be communicatively coupled to one another via a global network, a wide area network (WAN), or any other network type, and in some embodiments may be accessed via a portal, such as an Internet portal. Further, the user computer 102, which is shown as a personal computer, may be a handheld or a portable computing device. The server 104 preferably includes a plurality of programs, including but not limited to programs stored within the memory unit 118 for receiving and processing queries transmitted from the user computer 102 electronically. Similarly, each of the credit score reporting servers 106 and financial institution servers 108 preferably includes a plurality of programs, including but not limited to programs stored within memory units 132 and 140, respectively, for receiving and processing queries transmitted from the user computer 102 and the server 104 electronically. In certain preferred embodiments, the electronic transmission between the credit servers 106 and financial servers 108 and either the user computer 102 or the server 104 may occur through File Transfer Protocol (“FTP”), Internet Transfer Protocol (“TCP/IP”) or others. For security reasons, the electronic transmission may occur via dedicated communication lines that provide secured file transfers. In one embodiment, the server 104 is associated with a credit score generating and reporting business, and the database 104 is configured to maintain credit information on consumers generated by a plurality of credit score businesses, loan and credit card financial institutions, and utility and professional businesses. The credit information is structured to include a substantially accurate and complete credit history of consumers, with a high confidence level that all records belong to the appropriate consumers. As noted above, FIG. 2 is an exemplary embodiment of a system for implementing one or more methods and processes that will hereafter be described. Other embodiments understood by one of ordinary skill in the art are contemplated as well and considered within the scope of the disclosure.

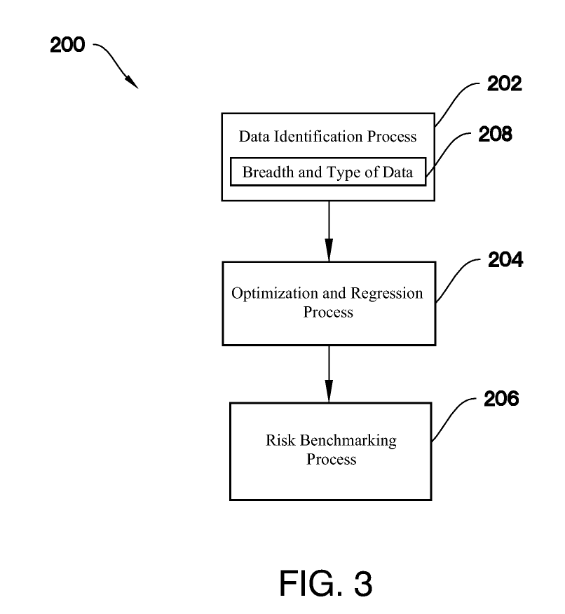

Now referring to FIG. 3, a process 200 for determining early-risk credit scores and flags, in accordance with a particular embodiment of the invention, is illustrated. As shown, the ERS flag process 200 utilizes a data identification process 202, an optimization process 204 and a benchmarking process 206. The data identification or set-up process 202 determines a breadth and type data 208 for the optimization and regression process 204. As shown in FIG. 4, the breadth of data 208, 302 combines traditional credit bureau attributes 304, triggers data 306, and risk tools 308. As stated above, the traditional attributes 304 can be used for development and implementation of scoring models, credit policy and decision rules for most aspects of the credit life cycle. Triggers data 306 serves to identify the changes or series of changes on a consumer's credit file over different periods of time, such as daily, weekly, monthly or greater. The changes in the consumer's credit file are identified by comparing the consumer's credit file from a specific point in time to a prior version of the consumer's credit file. This comparison allows the identification of changes to the consumer's credit file, i.e., the “change or triggers data.” The type of data can include trade-line level data versus consumer level performance data that may be included in traditional risk solutions. The risk tools 308 can be proprietary tools that are configured to measure and predict consumer risks to help predict financial integrity of consumers, which can be helpful in both the acquisition phase of new consumers and beneficial throughout an entire credit lifecycle. Referring back to FIG. 3, the optimization and regression process 204 is configured to identify the attributes or elements that strongly indicate risky consumer behavior, and fine tune the ERS solution to identify a specific percentage of risky credit profiles. The benchmarking module 206 is configured to enable the ERS solution to supplement and provide incremental risk values to existing credit solutions or scores, such as VantageScore® and FICO® (Fair Isaac Corporation). The benchmarking process 206 also allows for focusing on accounts that are likely to perform worse than their current risk profile indicates and adds value by identifying high risk accounts.

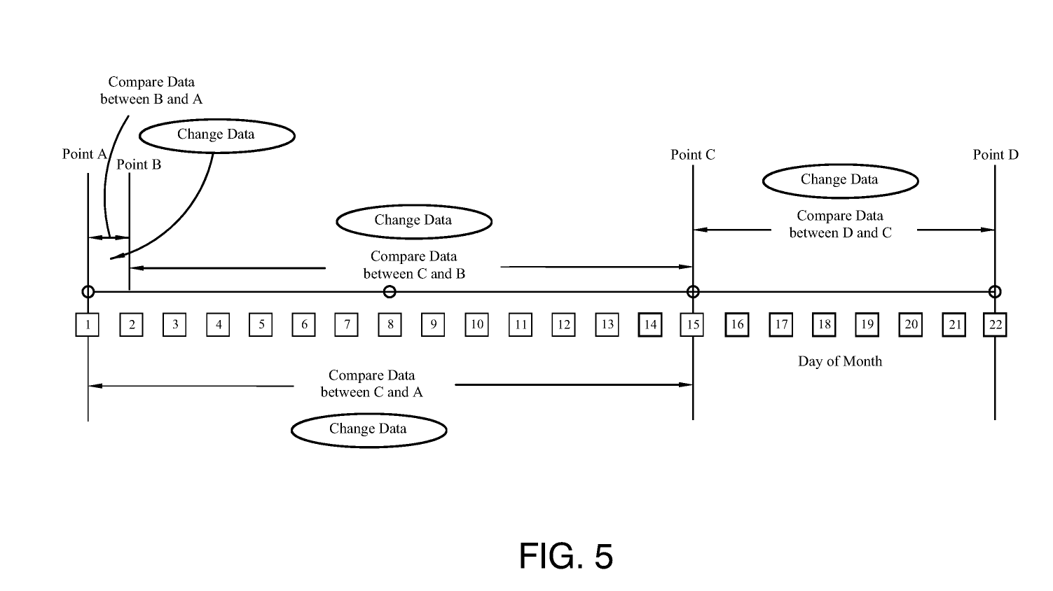

As shown in FIG. 5 and as stated above, triggers data 306 can be determined from a variety of time periods. In the example of FIG. 5, data is compared daily (between Day 1 or Point A and Day 2 or Point B), bi-weekly (between Day 1 and Day 15, as well as between Day 2 and Day 15 or Point C), and between Day 15 and Day 22 or Point D. The triggers data 306 provides a different perspective on the consumer's credit file and is predictive of future intent to open accounts and the future risk performance of the consumer. Examples of triggers data 306 include an increase of $1000.00 in total balances on all or almost all of a consumer's bank cards, an increase in the number of times that the consumer has been 60 days or greater past due or delinquent on an account, an increase or decrease in utilization of credit card accounts, and an increase or decrease in the number of open bankcard accounts.

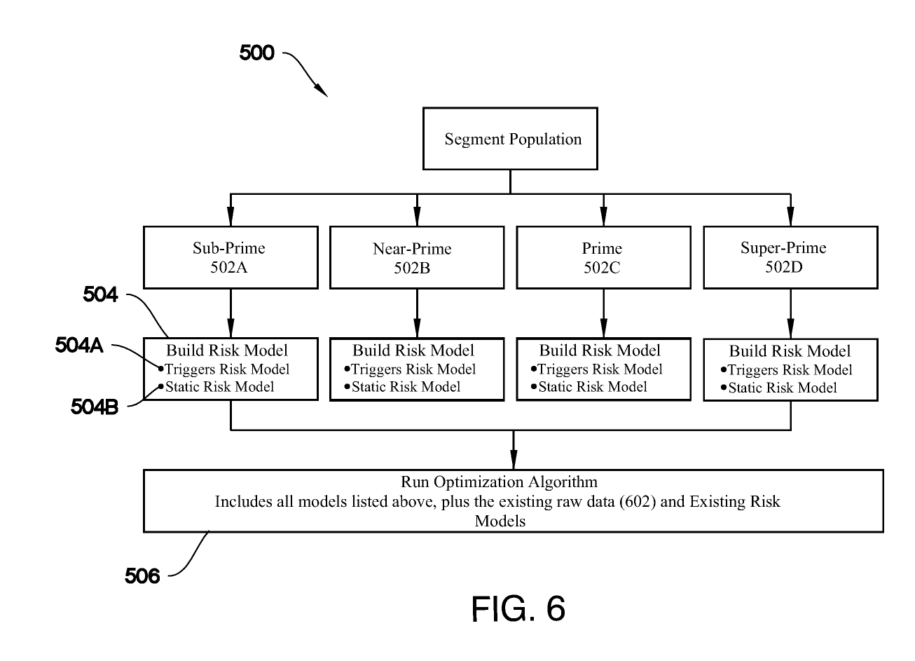

Now referring to FIG. 6, an optimization and regression process 500 for developing the ERS flag or solution is shown. The optimization process 500 includes a consumer population segmentation step 502, a risk model development step 504, and an optimization step 506. In the population segmentation step 502, the entire population of consumers is divided into a plurality of different segments. Consumers and their corresponding credit data can only be included into a single segment. The objective of the segmentation process 502 is to define a set of sub-populations that, when modeled individually and then combined, indicate risk more effectively than a single model tested on the overall population. This objective is achieved by dividing the total population according to characteristics that yield homogenous segments with respect to those characteristics. A typical credit risk model divides the consumer population into four segments: a sub-prime segment 502A, a near-prime segment 502B, a prime segment 502C and a super-prime segment 502D. Alternatively, the credit risk model may divide the consumer population into any number of suitable segments. For the sake of simplicity, these four segments 502A-502D will be used hereafter in the discussion of the other process steps to derive the ERS flag.

In the risk model process 504, multiple risk models are developed using credit data from consumers within each of the four segments 502A-502D. The multiple risk models include a trigger or change data risk model 504A and a static or standard risk model 504B. The trigger risk model 504A is built using triggers and select static credit data according to a standard modeling approach using logistic regression with binary outcomes. The standard or static risk model 504B is built in the same manner using traditional credit data and attributes. These two segment triggers and static risk models 504A and 504B are combined with individual change data elements and other known risk models such as VantageScore or any other known risk model suitable for new accounts and account management. Once all of the data is combined, the optimization process 506 is applied to determine the most predictive elements for each of the four segments 502A-502D, as well as the order of these predictive elements. The optimization process provides the means to identify elements predictive of higher risk while limiting the volume of the population selected. In one embodiment, the optimization process 506 determines the most predictive elements for the top ten percent (10%) of each of the four segments 502A-502D. Once the optimization process 506 is completed for each of the four segments 502A-502D, the most predictive elements from each segment 502A-502D are combined into the final ERS flag.

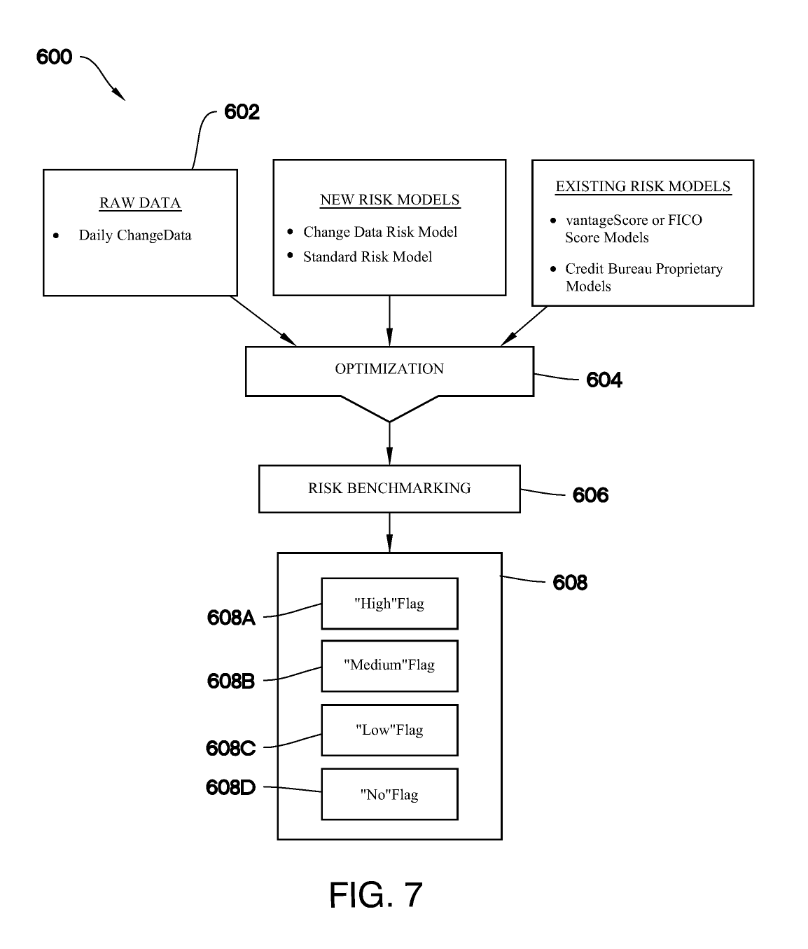

Now referring to FIG. 7, a process for benchmarking and generating flags is shown. Once the optimization process 604 is completed, a benchmarking process 606 benchmarks the ERS solution against existing traditional credit scores, such as VantageScore, to determine the increase in the identification of consumers that are likely to become 90 days or greater delinquent in the next 90-180 days. However, one of ordinary skill in the art will understand that the ERS solution could be benchmarked against any type of risk value or score to identify a wide array of risk characteristics. This identification increase can also be referred to as a lift in performance. The benchmarking process 606 involves comparing the percentage of consumers that are likely to become 90 or greater days past due for different segments of an existing traditional credit score, based on score ranges, to the elements identified in the optimization process in the ERS solution. This benchmark comparison helps to identify the lift for each of the predictive elements within the score range for the existing traditional credit score. Further, the benchmarking 606 enables the creation of ERS flags 608A-608D, “High”, “Medium”, “Low” and “No”, each of which represents a corresponding increase in the delinquency likelihood of the consumers. The ERS flags 608A-608D represent four different levels of increased risks, each of which can be identified by a corresponding alphanumeric number/value or a color. Although, in the following examples, each of the four levels will be identified by a corresponding color, it would be understood that alphanumeric values could also have been used. Moreover, alternatively, any other suitable number of different levels could also be utilized. “High” flag 608A is identified by the color “Red” to signify a ten (10) fold or times increased risk. “Medium” flag 608B is identified by the color “Orange” to signify a six (6) fold increased risk. “Low” flag 608C is identified by the color “Yellow” to signify a two (2) fold increased risk. “No” flag 608D is identified by the color “White” to signify a zero (0) fold or no increased risk. These flags 608A-608D are defined using the expected lift and the frequency of flags (volumes). The delivery of the ERS solution as a flag 608A-608D versus the traditional score range aids the use of the ERS solution in combination with traditional risk tools and practices.

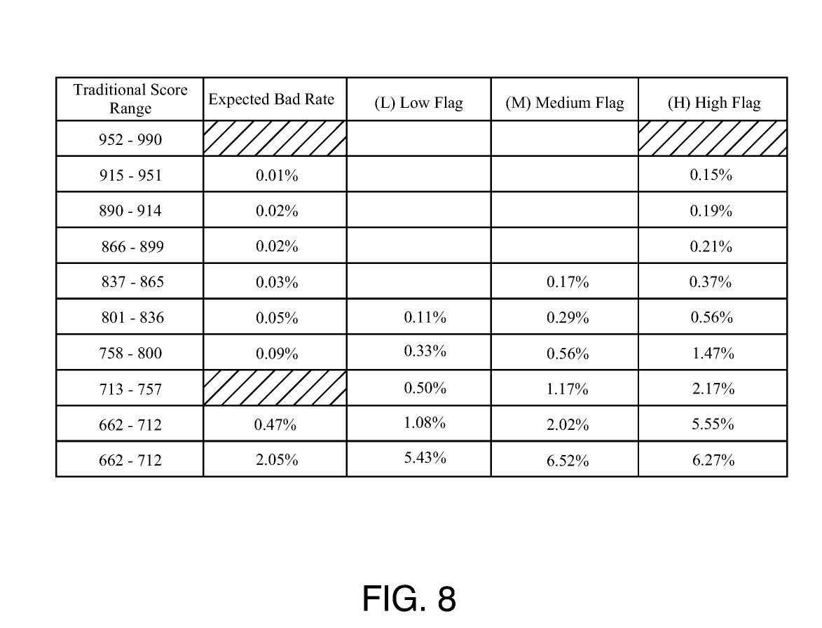

Rather than a traditional risk score, the ERS derivation process produces a flag that works with existing traditional scores, attributes and risk strategies to provide greater insight into a consumer's expected risk performance. Credit grantors can use the ERS in their risk management processes to identify consumers at increased risk and to take appropriate action on the account. The ERS flag can also be used in the account acquisition process to assist in making credit and pricing decisions. The ERS flag can identify consumers within a risk segment that will perform worse, i.e., have a higher likelihood to becoming 90 days or greater delinquent in the next 90-180 days than their traditional credit scores would suggest. As shown in FIG. 8, a consumer with a VantageScore in the range of 952-990 has an expected bad rate to become 90 days or greater delinquent, of 0.01%. However, this same consumer with an ERS flag of High has an expected bad rate of 0.18%. As such, the consumer's performance is actually closer to a consumer with a 713-757 VantageScore range. This ERS alteration in the consumer predicted performance allows a risk manager to identify accounts within their portfolio that will perform differently and determine what if any action they want to take on a consumer's credit account in their risk management process.

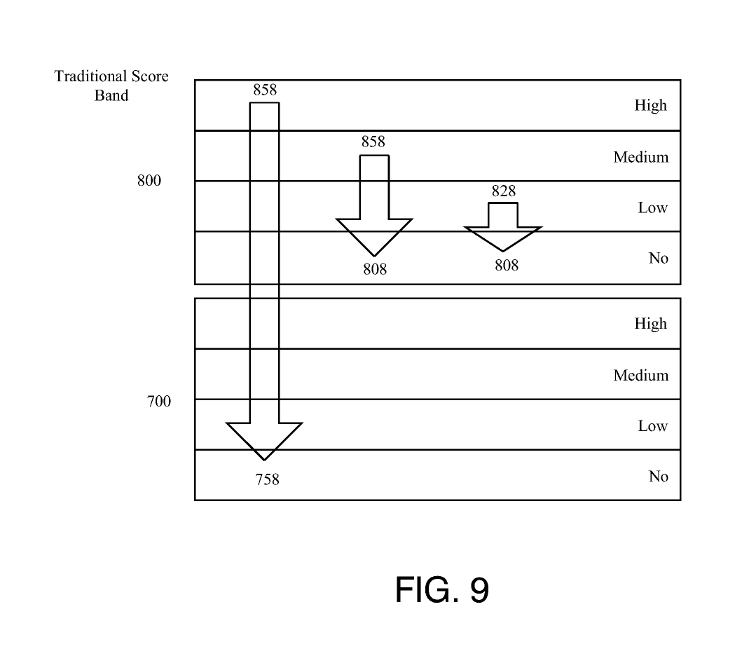

FIG. 9 illustrates this correlation further. FIG. 9 shows two specific accounts A and B having similar “858” VantageScores. The first account, Account A, has a “High” ERS flag with expected performance closer to a VantageScore of “758” with a “No” ERS flag. The second account, Account B, also has an “858” VantageScore but with a “Medium” ERS flag with expected performance closer to a VantageScore of “808”. A third account, Account C, has a “828” VantageScore and a “Low” ERS flag with expected performance closer to a VantageScore of “808” with a No ERS flag.

Without taking into consideration their respective ERS flags, both existing accounts A and B would be erroneously managed with the same risk treatment strategy with a high VantageScore. The different ERS flags identify potentially different performance of the two accounts and thus allow differentiated treatment. To illustrate these different treatments, the amount that each account A, B or C would be allowed to exceed the credit limit on their credit card account, may be derived, as follows:
The standard risk treatment strategy for accounts with a moderate to low risk profile is to allow them to exceed their credit limit by up to about 5%—also referred to as the over-limit amount.
Account A with a “High” ERS flag is expected to perform much worse than its current risk profile and as a result will have the over-limit tolerance level reduced to 1%, the amount allowed for accounts with a 758 VantageScore.
Account B with a “Medium” ERS flag is expected to perform worse than its current risk profile and will have the over-limit tolerance level reduced to 3%, the amount allowed for accounts with an 808 VantageScore.
Account C with a “Low” ERS flag and a lower difference in performance does not require any risk treatment changes.

Therefore, the ERS flags enable the treatment outlined above that would not be possible using standard risk solutions alone. Thus, the combination of the ERS flag and existing risk tools allows risk managers to more effectively manage the risk in their portfolio of accounts.

ERS flags can also impact the acquisition of new accounts. For example, the three accounts A-C shown in FIG. 9 are now considered to be new accounts. Again, Account A has a “High” ERS flag, Account B has a “Medium” ERS flag, and Account C has a “Low” ERS flag. Credit limit and pricing are used to show how the ERS flags affect the acquisition and treatment of accounts. This example also assumes that other items such as income and overall debt burden are the same for these accounts. Using ERS flags, the account treatment would be as follows:
The standard credit limit and pricing for a credit card account with an 858 VantageScore is $15,000 at prime rate plus 9.99%.
Account A with a “High” ERS flag may receive a credit limit of $7,500 and pricing of prime plus 12.99%—the same as other approved accounts with a 758 VantageScore.
Account B with a “Medium” ERS flag may receive a credit limit of $12,000 with pricing of prime plus 11.49%—the same as other approved accounts with an 808 VantageScore.
Account C with a “Low” ERS flag may receive a credit limit of $12,000 with pricing of primate plus 11.49%—the same as other approved accounts with an 808 VantageScore.

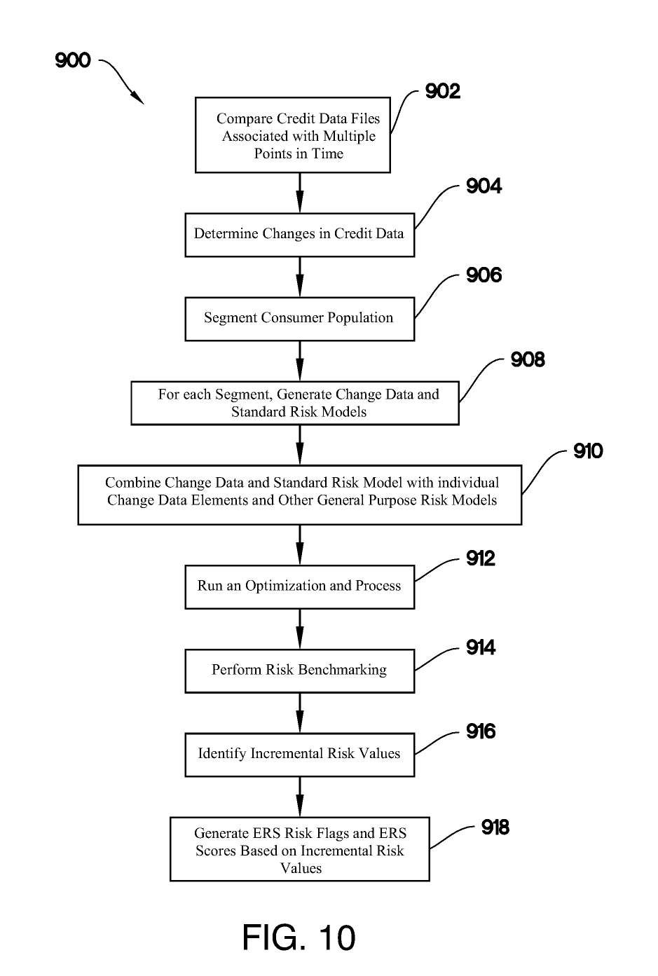

Now referring to FIG. 10, a flow diagram 900 illustrates the process or method for generating risk solution flags representative of increased levels of risk of accounts becoming 90 days or greater delinquent in a predetermined future period in accordance with the present invention. As stated above, once the consumer's credit file, from a specific point in time, is compared to a prior version of the consumer's credit file, at Step 902, changes in data are established, at Step 904. Subsequently, at Step 906, the consumer population is divided into segments based on expected use, such as Sub-prime, Near-prime, Prime and Super-prime segments. For each segment, two new risk models are generated, using as Change or Trigger Data and Static or Standard Data, at Step 908. These two generated risk models are combined with individual Change Data elements and other general purpose risk models, at Step 910. The combined data is used in an optimization and regression process to identify the most predictive elements for each consumer segment as well as the order of these predictive elements, at Step to 912. The most predictive elements from each segment are then combined to generate the ERS solution. Subsequently, to perform a risk benchmarking, individual predictive elements in the ERS solution are compared to bad rates for different segments of an existing credit score, at Step 914. Incremental risk values for each consumer are then derived from the risk benchmarking process, at Step 916. Based on the derived incremental risk values, an ERS risk flag is generated to reflect a corresponding future higher risk performance for each of the consumers, at Step 918. A corresponding ERS score can also be generated to provide a comparison with one of the consumer's existing credit score, thereby illustrating the future higher risk performance, if any, associated with each consumer.

Although exemplary embodiments of the invention have been described in detail above, those skilled in the art will readily appreciate that many additional modifications may be possible in the exemplary embodiment without materially departing from the novel teachings and advantages of the invention. Accordingly, these and all such modifications are intended to be included within the scope of this invention.

1. A computer readable storage medium having a code stored therein for effectuating a method for improving prediction of credit risk performances of a plurality of consumers, each consumer having a standard credit data file and score, the code comprising:
a first code segment for receiving changes in credit data files of the plurality of consumers during a predetermined period of time;
a second code segment for combining change data with standard credit data;
a third code segment for determining a set of credit elements that are predictive of credit risk performances of the plurality of customers by processing the combined change data and standard credit data;
a fourth code segment for identifying an incremental risk value for each of the plurality of consumers by supplementing the corresponding credit data file with the predictive set of credit elements; and
a fifth code segment for generating a flag indicative of the identified incremental risk value for each of the plurality of consumers.

2. The medium of claim 1 further comprising a sixth code segment for dividing the plurality of consumers into a plurality of segments.

3. The medium of claim 2 further comprising a seventh code segment for generating at least one risk model for each consumer segment.

4. The medium of claim 3 wherein the risk model is based on standard credit data and attributes.

5. The medium of claim 3 wherein the risk model is based on change or triggers data.

6. The medium of claim 2 wherein the plurality of segments comprises sub-prime, near-prime, prime, and super-prime.

7. The medium of claim 1 wherein the flag is selected from a group consisting of high, medium, low, and no.

8. The medium of claim 1 wherein the standard credit data is VantageScore, FICO score, or any other generated risk value.

9. A method of determining risk of consumer credit delinquency over a predetermined time period comprising the steps of:
receiving at a computer a credit data file for a consumer;
having the computer access the portion of the credit data file comprising consumer payment history data for all consumer accounts;
comparing the credit file data from a first point in time to the payment history data from a second point in time;
determining whether there is any difference in the payment history data between the first point in time and the second point in time; and
recording onto a computer storage medium any determined difference in the payment history data.

10. The method of claim 9 further comprising the steps of
comparing the payment history data from the first point in time to the payment history data from a third point in time; and
determining whether there is any difference in the payment history data between the first point in time and the third point in time.

11. The method of claim 9 further comprising the steps of
comparing the payment history data from the second point in time to the payment history data from a third point in time; and
determining whether there is any difference in the payment history data between the second point in time and the third point in time.

12. The method of claim 11 further comprising the steps of
comparing the payment history data from the third point in time to the payment history data from a fourth point in time; and
determining whether there is any difference in the payment history data between the third point in time and the fourth point in time.

13. The method of claim 9 wherein the difference between the first point in time and second point in time is one day.

14. The method of claim 9 wherein the difference between the first point in time and second point in time is two weeks.

15. The method of claim 9 wherein the difference between the first point in time and second point in time is half a month.

16. A method for modifying consumer credit scores according to an early-risk profile comprising the steps of:
receiving at a computer a credit data file for a plurality of consumers;
using the credit data to generate change data for each consumer;
dividing the plurality of consumers into a plurality of segments;
generating at least one risk model for each consumer segment;
combining the change data and risk model together with a predetermined risk model;
calculating an optimized risk trend based on the change data and risk models;
benchmarking the change data for each consumer against the optimized risk trend;
identifying incremental risk values based on the number of consumers that fall at each position on the optimized risk trend; and
generating an early-risk score or flag for each consumer based on the identified incremental risk values.

17. The method of claim 16 wherein the risk model is based on standard credit data and attributes.

18. The method of claim 16 wherein the risk model is based on change data.

19. The method of claim 16 wherein the plurality of segments comprises sub-prime, near-prime, prime, and super-prime.

20. The method of claim 16 wherein the early-risk score or flag is selected from a group consisting of high, medium, low, and no.
